(19) United States
(12) Patent Application Publication
(10) Pub. No.: US 2010/0056173 A1
(43) Pub. Date: Mar. 4, 2010

(54) SYSTEM FOR CONTEXT-DEPENDENT ALERTS, INCLUDING DISTANCE PROXIMITY ALERTS, AND ANONYMOUS COMMUNICATION BY USERS OF WIRELESS MOBILE DEVICES

(76) Inventors: Alex Bloom, Beverly Hills, CA (US); Alexander Ganelis, Beverly Hills, CA (US)

Correspondence Address: Alex Bloom, 9663 Santa Monica Blvd, #177, Beverly Hills, CA, 90210, US

(21) Appl. No.: 12/200,858

(22) Filed: Aug. 28, 2008

(51) Int. Cl. H04W 4/02

(52) U.S. Cl. 455/456.1

(57) ABSTRACT

A system for issuing a notification alert on user's mobile device whenever another user is within a short distance or in the same general area, as further detailed below. Users may or may not have any previous knowledge of each other in order for both to receive the proximity alert. Users who don't have any previous knowledge of each other (“non-friends”) are able to specify a number of characteristics (age, gender, etc.) and be both alerted only when they are in proximity and mutually satisfy their respective preferences. Following the alert, the system also enables users to exchange any number of anonymous messages that do not contain users' contact information.

### FIELD OF THE INVENTION

This invention is in the field of technology for wireless mobile devices broadly known as Location Based Services. This is an area for a wide range of applications that take advantage of knowing users' physical locations and thus being able to determine users' proximity with respect to each other as well as users' proximity to various businesses and points of interest.

### BACKGROUND OF THE INVENTION

People seek to meet each other for a variety of reasons including common interests and hobbies, romantic relationships, as well as professional and networking opportunities. In many cases a personal face-to-face meeting is absolutely indispensable. As people move around in the course of their daily lives, they likely often happen to be in proximity of other people who would match their meeting preferences, for example a fellow hobby enthusiast or a person of the right profile (age, gender, etc.) also seeking a romantic relationship. As a growing percentage of individuals, approaching 100% in many areas, always carries with them a wireless mobile device, commonly referred to as a cellular or mobile phone, it is possible to estimate peoples' physical locations, mutually alert them when there is a proximate user with matching characteristics, and to enable them to exchange anonymous text messages (that do not contain their phone numbers or e-mails) so they can correspond as to their exact location and readiness to meet right away. Innovative algorithms are required to enable such services giving consideration to issues such as device battery drain as well as additional data traffic generated and possible extra cost associated with it. Such algorithms comprise this invention. Currently, the technology does not exist that would enable a “proximity alert” service as per above for users of cellular phones with a number of critical features including:
Nearly simultaneous alerts so both users get notified of their proximity within a short time of each other.
No requirement for active user input, that is whenever the right user happens to be within a short distance, alerts are generated even though both users may not have interacted with the software in any way beyond the initial set-up.
Very reasonable effects on battery life and additional data transfers that don't hinder normal use of the device for all other purposes.
Anonymous and rapid message exchange, that is when users exchange messages, the exchange is “real time” with only a short time elapsing between sending of the message by the sender and its receipt by the recipient.

This invention, comprised of innovative algorithms, enables all this functionality, whereas no present technology does.

### SUMMARY OF THE INVENTION

A system for issuing a notification alert on user's mobile device whenever another user is within a short distance or in the same general area, as further detailed below. Users may or may not have any previous knowledge of each other in order for both to receive the proximity alert. Users who don't have any previous knowledge of each other (“non-friends”) are able to specify a number of characteristics (age, gender, etc.) and be both alerted only when they are in proximity and mutually satisfy their respective preferences. Following the alert, the system also enables users to exchange any number of anonymous messages that do not contain users' contact information,

### DETAILED DESCRIPTION

This invention can be utilized in a variety of ways and for a variety of purposes. By way of example, we will focus on a particular use, which can be easily generalized.

The functional invention is comprised of the following hardware and software components (please see drawing):
Ordinary cellular phones or other mobile wireless devices in active use.
Special purpose software that can be installed and run on wireless devices, hereafter referred to as Client Software or Client.
A central server comprised of one or more stationary computers connected to the Internet.
Special purpose software installed and run on the central server(s), hereafter referred to as Server Software or Server.

Client and Server Software are based on the algorithms that constitute the claims of this invention.

A cellular phone user utilizing the invention has the ability to specify the characteristics of persons he/she would like to meet as well as his/her own characteristics. As users move around with Client Software running on their cellular phones, the Server Software periodically receives location and possibly other information from Client, as further specified below. When two users happen to be within a distance not exceeding a certain threshold, their phones alert them via sound and/or vibration. In addition to the alert, phones display certain information on the screen such as a photograph and information about the other person (age, gender, etc.). Upon and following the alert, the Client Software also enables the two users to exchange anonymous messages which are sent via Server Software and as such don't contain users' phone numbers or any other identifying information, hence such messages are anonymous.

By way of example, User A may be male, 32 years of age; User B may be female, 35 years of age. User A may be interested in meeting females between the ages of 30 and 40 for a romantic relationship; and User B may be interested in meeting males between the ages of 25 and 45 for a romantic relationship. If the distance between such two users falls below a certain threshold set within the Server Software (either by the operators of the service or by users themselves), they will receive the alert as described above, be able to exchange anonymous messages, and possibly decide to meet right away. In general, this “proximity-sensitive” technology can be applied to a variety of areas from networking at trade shows and conferences to multi-player games.

Client and Server Software should contain certain key algorithmic components, which together comprise the invention.

Client should make periodic network requests to the Server, for example once every five minutes. It is important for Client to make periodic requests rather than to maintain a persistent connection with the Server in order to reduce battery drain to an acceptable level as well as to reduce the amount of data transferred over the network.

For devices on which too many prompts require user action for each request, periodic request are impractical, and the user needs to actively initiate a request when he/she wishes to be informed if there is a proximate matching user.

Depending on the device, the program retrieves either GPS coordinates (if GPS unit is available and accessible to a third party program on the device) and/or the cellular tower ID along with a number of other parameters such as network ID, frequency, and some other parameters depending on the cellular network of a given device, hereafter Tower Info.

As some devices may only send Tower Info while others send tower info and GPS coordinates, there are the following algorithmic components that are used to determine or estimate proximity in various cases.

The last GPS coordinates, if any, and the last Tower Info received from Client are stored for each user on the server and updated with each Client request.

For each cellular tower a list is maintained with GPS coordinates ever received in Client requests that contained both Tower Info and GPS coordinates. We thus build a list of all GPS coordinates ever associated with a given tower with the purpose of being able to estimate tower location in requests that only contain Tower Info and no GPS coordinates. A number of operations can be used to estimate tower location from the list of associated GPS coordinates. The simplest method is an arithmetic average of all latitudes and longitudes ever received for a given tower, updated when a new set of GPS coordinates is received.

When Client request is received from User A, a distance estimate is attempted for all users stored on the server who otherwise meet the various other alert criteria such as mutually matching characteristics, time elapsed since this pair last received an alert for each other (if any), possible restrictions on time of day and others. We will refer to each such prospective alert user for whom a distance determination needs to be made as User B. The following cases are possible.

Both User A and User B have GPS coordinates (here and below User A has his/her latest data in the current Client request now being processed by the Server while User B has his/her info stored on the server). Server Software computes the actual geodesic distance between the two sets of coordinates and clears the distance condition if such distance is below a certain GPS threshold (either set by the operators of the service or enabling users to set it for themselves). Alternative less computationally costly methods can be used for computing distance such as, for example, computing a difference separately between latitudes and longitudes and applying a different threshold to each such difference (since 1 degree of latitude and 1 degree of longitude are not equal in distance).

If at least one of the users does not have GPS coordinates but for the one or both without GPS coordinates, their tower location can be estimated from the Tower Location Database. Then the distance calculation is made between the estimated tower locations, subject to the same discussion as per above, and possibly a different threshold is used to trigger the alert.

If at least one of the users does not have GPS coordinates and his/her tower is not contained in the Tower Location Database (i.e., no user of the service has ever supplied GPS coordinates with this tower before). Then cellular towers of the users are compared and if both users happen to use the same physical tower, the alert is triggered.

In some combinations of these conditions operators of the service can decide which criterion should prevail, for example, whether to trigger the alert if both users have GPS coordinates and the distance between them exceeds the threshold but they both use the same cellular tower.

The notion of the “same cellular tower” normally implies that the two users in question use the same wireless carrier otherwise they cannot normally have the same physical tower, unless it is known that two different carriers both use certain towers or that Tower ID1 by Carrier 1 is physically the same tower as Tower ID2 by Carrier 2.

If User A and User B clear all conditions for the alert including the distance condition as per above, User A (whose request is being processed) gets a special response from the server that triggers alert behavior in the Client Software. There is no way to trigger alert for User B's Client immediately as no Client maintains persistent connection. Consequently, User B is “marked” on the server in such a way that when User B's Client sends its periodic request, Server Software sends back the special alert response with User A's information which will trigger the alert for User B's Client Software.

Once two users have been “introduced” via alerts as per above, Client and Server Software enable them to exchange anonymous messages, i.e., messages that do not contain users' personal contact information such as e-mail or phone number. When User A enters and sends a message to User B using Client Software, Client Software sends the message over the Internet to the Server where it is stored with some unique identifier of User A, the sender, and User B, the recipient. When User B client connects to the server in its periodic request, the Server sends back a special response with the message text that causes Client Software to alert User B and display the message with a possibility to reply which would repeat the sequence with User B now being the sender and User A the recipient.

An important part of the invention for exchanging messages is the “Match Mode”—a special mode that Client enters into upon receiving a meeting (proximity) alert, or upon receiving a message from another user, or upon sending a message. In Match Mode Client sends its periodic requests to the Server with a much higher frequency, for example once every 30 seconds, whereas in the normal mode, the frequency may be once every five minutes. Since no Client maintains a persistent connection, Match Mode enables a rapid “real time” message exchange since each Client in a messaging pair makes a frequent contact with the Server. Note that a “messaging pair” does not necessarily mean that at least one message has already been sent, but it may mean that messages are now likely to be sent as it happens following a meeting alert, which causes each Client to enter the Match Mode upon receiving the alert.

Match Mode lasts for a specified length of time after which Client returns back to normal mode. Since each send-out or receipt of the message re-starts the clock for the time remaining in Match Mode, users can have a rapid message exchange for as long as they keep on messaging.

The following figure illustrates an example embodiment of invention.

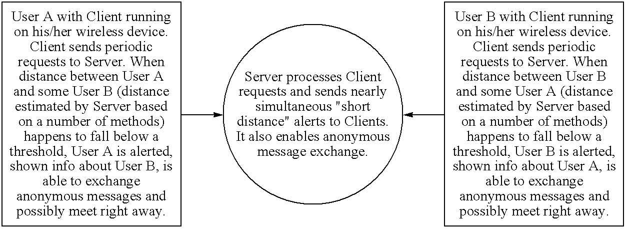

What is claimed is:

1. A method for a nearly simultaneous notification alert of the two users who happen to be in physical proximity of each other.

2. A method for each mobile device making periodic requests to the central server using either a standard or proprietary protocol. Such requests can be quite infrequent, by way of example, one request in every five minutes, and therefore there is no persistent connection between the Program and the central server. Avoiding a persistent connection significantly reduces the amount of data sent and received by the mobile device and reduces the additional battery drain caused by the Service.

3. A method for enabling two users to exchange anonymous messages that do not contain their contact information such as e-mail or phone number, unless such information is purposely typed in by the user as part of the message.

4. The method as recited in claim 2, wherein location-dependent information is transmitted with each request to the central server, such information being determined by the user's physical location using a number of methods as specified below.

5. The method as recited in claim 4, wherein the device is equipped with the Global Positioning System (GPS) unit and such unit's output is accessible by the Program. The program transmits to the central server, with some or all periodic requests, the latitude and longitude obtained from the GPS unit.

6. The method as recited in claim 5, wherein the Program also transmits to the central server the identifier number(s) of the cellular tower(s) currently serving the device.

7. The method as recited in claim 6, wherein the central server stores GPS coordinates and the corresponding cellular tower(s) identifier(s) received with the periodic request. As the number of GPS coordinates received for each cellular tower rises in the database, hereafter “Tower Location Database”, the current tower location can be estimated based on the tower identifier(s) with rising precision.

8. The method as recited in claim 1, wherein the user may choose to run the Program passively in the background and receive an alert based on the proximate location of another user, without any active input or participation required by either user in order to generate the alert.

9. The method as recited in claim 1, wherein a user may choose to provide his or her location manually in the Program and receive alerts upon such entry based on the location entered.

10. The method as recited in claim 8, wherein a user may choose to limit his or her alerts subject to a variety of conditions, including, without limitation, matching characteristics and preferences, time since the last alert, etc., and such conditions will be additional to the proximity condition.

11. The method as recite in claim 2, wherein nearly simultaneous alerts are enabled in absence of the persistent connection between the Program and the central server. When the central server receives location information with a periodic request sent by the Program running on User A's device, the central server stores such information and determines whether there is location information last sent by User B's Program such that it lies within the alert distance threshold from User A's location. If for User A's location information, the central server finds location information last sent by User B whose location is within the alert distance threshold, and decides to proceed with an alert subject to a number of other conditions (matching user preferences, etc.), the central server sends a special alert response to User A's Program and marks User B on the server as an alert user. When User B's program sends its next periodic request, which is the very first request after User B was alert-marked on the server as per above, the server sends back to User B a special alert response because of User B's mark as an alert user. A special alert response by the server causes the Program to issue an alert by way of sound and/or vibration and display the relevant information on the screen.

12. The method as recited in claim 11, wherein if User A receives an alert with User B, alerting User A to User B's proximity, User A is able to view User B's non-private information provided at registration, including User B's photograph.

13. The method as recited in claim 12, wherein a server sends a URL to an alert user's Program, from which alert user's Program retrieves the photograph.

14. The method as recited in claim 11, wherein whether two sets of location information are within an alert distance threshold is determined as follows. If both User A and User B provide GPS coordinates, the distance is calculated and compared against a simple distance threshold.

15. The method as recited in claim 14, wherein the distance between two points is not calculated but in order to reduce the computational workload, the difference is calculated separately between respective latitudes and longitudes and each such difference is compared against its own threshold. This method results in two subtractions, one for latitude and one for longitude, and two comparisons, one for latitude and one for longitude.

16. The method as recited in claim 11, wherein whether two sets of location information are within an alert distance threshold is determined as follows. If at least one of the users does not provide GPS coordinates but for each of the one or both non-GPS reporting users, cellular tower GPS coordinates can be estimated via Tower Location Database maintained by the Service or by a third party vendor, such tower UPS coordinates estimates are made and the same distance determination method is used as in claims 14 and 15 but with a different threshold.

17. The method as recited in claim 11, wherein whether two sets of location information are within an alert distance threshold is determined as follows. If at least one user does not report GPS coordinates and such user's cellular tower coordinates cannot be estimated via Tower Location Database or a third-party vendor, then users' cellular carriers (phone companies) are compared. If both users have the same wireless carrier and their cellular tower identifier numbers are also equal, then the two users are presumed to be within an alert distance threshold and they both receive an alert.

18. The method as recited in claim 3, wherein the Program continues not to maintain a persistent connection but in order to accelerate the send-receive-reply sequence, the frequency of connecting to the central server is increased right upon receiving the alert. By way of example, if the normal frequency is once every five minutes, the frequency automatically rises to once every thirty seconds following the alert in order to enable rapid message exchange. The higher frequency lasts a specified period of time after which it returns back to normal. The frequency also automatically rises if a user initiates a message some time after the alert when the frequency is already back to normal, again with the same purpose of enabling a rapid message exchange.

19. The method as recited in claim 1, wherein each alert user can find the profile of the other “matching” alert user and exchange anonymous messages with the other matching alert user any time (a year later for example) after receiving the alert, from either the mobile Program or on the Service website.

20. The method as recited in claim 4, wherein a given user is shown an approximate location of one or more users who match given user's preferences. Thus a given user is able to determine which specific areas in his or her general geographic area currently contain potential alert users and guide a given user in his movements should he or she wish to get an alert and meet other users of the Service.
